(19) United States
(12) Patent Application Publication
(10) Pub. No.: US 2012/0075447 A1
(43) Pub. Date: Mar. 29, 2012

(54) ENDOSCOPE SYSTEM

(75) Inventor: Kosuke IWANE, Ashigara-kami-gun (JP)

(73) Assignee: FUJIFILM CORPORATION, Tokyo (JP)

(21) Appl. No.: 13/247,383

(22) Filed: Sep. 28, 2011

(30) Foreign Application Priority Data
Sep. 29, 2010 (JP) 2010-218984

(51) Int. Cl. H04N 7/18

(52) U.S. Cl. 348/65; 348/E07.085

(57) ABSTRACT

A correction image is created from an image captured by a solid-state image sensor and low-frequency components are removed from the correction image to generate a correction parameter for correcting uneven sensitivity, the endoscope system is capable of correcting uneven sensitivity of the image captured by the solid-state image sensor without amplifying noise in the periphery of the image.

### BACKGROUND OF THE INVENTION

The present invention belongs to the technical field of endoscope systems and more specifically relates to an endoscope system capable of properly correcting uneven sensitivity while suppressing the amplification of noise due to deterioration of marginal luminosity.

Endoscopes (electronic endoscopes) are used to make a diagnosis as to whether a living body has a lesion or to what extent a lesion is advanced.

An endoscope irradiates part of a living body with light, captures reflected light with a (solid-state) image sensor such as a CCD sensor and displays the captured image on a display. A physician determines the state of a lesion by observing changes in the color, brightness, structure and the like of the surface of the living body.

As is well known, the image sensor for capturing images is of a two-dimensional array of pixels for capturing images (measurement points of the quantity of light).

The pixels of the image sensor do not have completely uniform characteristics but the image sensor have pixel to pixel sensitivity variations (sensitivity unevenness). The pixel-to-pixel variations are caused not only by the characteristics of the solid-state image sensor but also the characteristics of the lens (e.g., deterioration of marginal luminosity), the state of the light-receiving surface of the image sensor, and the state of the lens surface.

A proper image cannot be captured by such an image sensor having characteristic variations (individual variations). Particularly in endoscopes used for medical purposes, diagnosis using an improper image is a serious problem that may lead to an erroneous diagnosis.

Therefore, as described in JP 2005-211231 A and JP 8-191440 A, the endoscopes correct uneven sensitivity of an image captured by an image sensor so that a proper image having no image quality deterioration due to pixel-to pixel variations may be output.

In the endoscopes, uneven sensitivity is usually corrected by previously calculating and storing a parameter for correcting uneven sensitivity for each pixel and correcting (processing) image data of each pixel on a captured image with its corresponding correction parameter.

As described above, the characteristic variations of the solid-state image sensor also depends on the characteristics of the solid-state image sensor and the states of the lens and the light receiving surface. Therefore, uneven sensitivity is to be corrected with the lens mounted on the endoscope.

Therefore, as also described in JP 2005-211231 A and JP 8-191440 A, correction parameters for correcting uneven sensitivity are obtained by a method which involves capturing with an endoscope an image of an object having an entirely uniform concentration such as a white object, analyzing the image and producing for each pixel a correction parameter which enables the image to be output as an image which is uniform on the entire screen.

However, as is well known, the imaging lens of the endoscope is a very compact and wide-angle lens. Therefore, the lens distortion is large and the quantity of light reduces more considerably in the peripheral portion than in the central portion.

Uneven sensitivity correction performed with uneven quantity of light so as to make the image uniform on the whole surface may increase the amount of correction (amount of amplification) in the peripheral portion compared to the central portion. As a result, the peripheral portion of the image has an increased noise level and on the other hand the image quality may deteriorate on the entire image.

An object of the invention is to solve the problems associated with the prior art and to provide an endoscope system in which a diagnosis is made based on an image captured by a solid-state image sensor, wherein uneven sensitivity can be corrected to prevent noise due to deterioration of marginal luminosity from being enhanced to thereby output an image which is properly corrected for unevenness as a whole and is capable of a correct diagnosis.

### SUMMARY OF THE INVENTION

In order to achieve the above object, the present invention provides an endoscope system, including: an endoscope for capturing an image with an image sensor; storage means for storing an uneven sensitivity correction parameter; uneven sensitivity correction means for correcting uneven sensitivity of the image sensor using the uneven sensitivity correction parameter stored in the storage means; and parameter generating means for generating the uneven sensitivity correction parameter, wherein the parameter generating means creates a correction image from the image captured by the image sensor and generates the uneven sensitivity correction parameter so as to correct only high-frequency components of the correction image.

In the endoscope system of the present invention, it is preferable that the parameter generating means extracts the high-frequency components from the correction image and generates the uneven sensitivity correction parameter so that the extracted high-frequency components are only corrected for the uneven sensitivity.

Further, it is preferable that the parameter generating means generates a temporary uneven sensitivity correction parameter for entirely correcting the uneven sensitivity of the correction image and corrects the temporary uneven sensitivity correction parameter with information previously acquired on shading of the endoscope to generate the uneven sensitivity correction parameter.

Further, it is preferable that the parameter generating means generates the uneven sensitivity correction parameter so that a central portion of the correction image is only corrected for the uneven sensitivity.

Further, it is preferable that the central portion of the correction image is preferably a region of image data whose quantity of light is at least two-thirds that of a center.

Further, it is preferable that the parameter generating means divides the correction image into segments and generates the uneven sensitivity correction parameter so that the uneven sensitivity is corrected for each of the segments.

Further, it is preferable that the endoscope system has a function of observation under special light.

Further, it is preferable that the parameter generating means selects a predetermined number of images by thinning out images captured by the image sensor for creating the correction image and uses the predetermined number of selected images to create the correction image.

Further, it is preferable that when average image data of a specified region in an image of the predetermined number of selected images is outside a prescribed range, the parameter generating means does not use the image to create the correction image.

Further, it is preferable that when an image of the predetermined number of selected images does not have variations exceeding a specified threshold with respect to a specified image for judgment, the parameter generating means does not use the image to create the correction image.

Furthermore, it is preferable that the storage means and the uneven sensitivity correction means are disposed in the endoscope. The parameter generating means may be disposed in the endoscope or in a portion other than the endoscope.

According to the inventive endoscope system having the foregoing configuration, uneven sensitivity is corrected so that dispersion of the low-frequency components on the entire image due to deterioration of marginal luminosity or the like is removed to correct only dispersion of the high-frequency components which may be easily mistaken for a lesion.

Therefore, in the endoscope system of the invention, noise in the peripheral portion can be prevented from being enhanced by deterioration of luminosity or the like to output an image which is properly corrected for unevenness as a whole and is capable of a correct diagnosis.

### BRIEF DESCRIPTION OF THE DRAWINGS

FIG. 1 conceptually shows an embodiment of an endoscope system of the invention.

FIG. 2A is a conceptual block diagram showing the configuration of a scope portion of an endoscope; and FIG. 2B is a conceptual block diagram showing the configuration of a video connector of the endoscope.

FIG. 3 is a conceptual block diagram showing the configuration of the endoscope system shown in FIG. 1.

FIG. 4 is a flow chart for illustrating a method of creating a correction image.

FIG. 5 is a conceptual view for illustrating a method of generating a parameter for correcting uneven sensitivity.

### DETAILED DESCRIPTION OF THE INVENTION

On the following pages, an endoscope system of the invention is described in detail with reference to the preferred embodiments illustrated in the accompanying drawings.

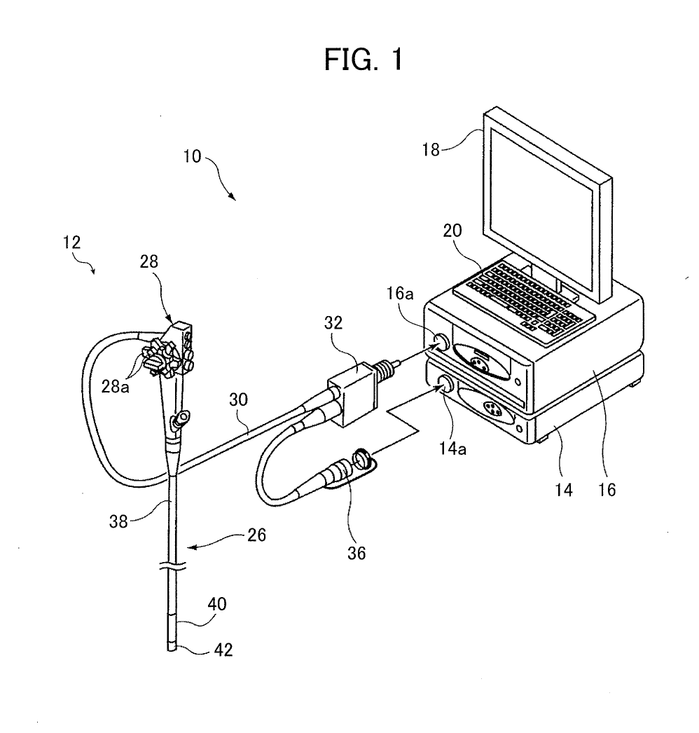

FIG. 1 conceptually shows an embodiment of an endoscope system of the invention.

The endoscope system 10 shown in FIG. 1 includes an endoscope 12, a processor 14 for processing an image captured by the endoscope 12, a light source device 16 for supplying illumination light for use in endoscopic photography and observation, a monitor 18 for displaying the image captured by the endoscope 12, and an input device 20 for inputting various instructions.

As in a typical endoscope, the endoscope 12 includes, as shown in FIG. 1, an insertion section 26, an operating section 28, a universal cord 30, a connector 32 and a video connector 36. As also in a typical endoscope, the insertion section 26 includes a long flexible portion 38 on the proximal side, a distal scope portion (endoscope distal portion) 42 provided with a CCD sensor 48 or the like, and a bending portion (angle portion) 40 located between the flexible portion 38 and the scope portion 42. The operating section 28 includes manipulation knobs 28a for bending the bending portion 40.

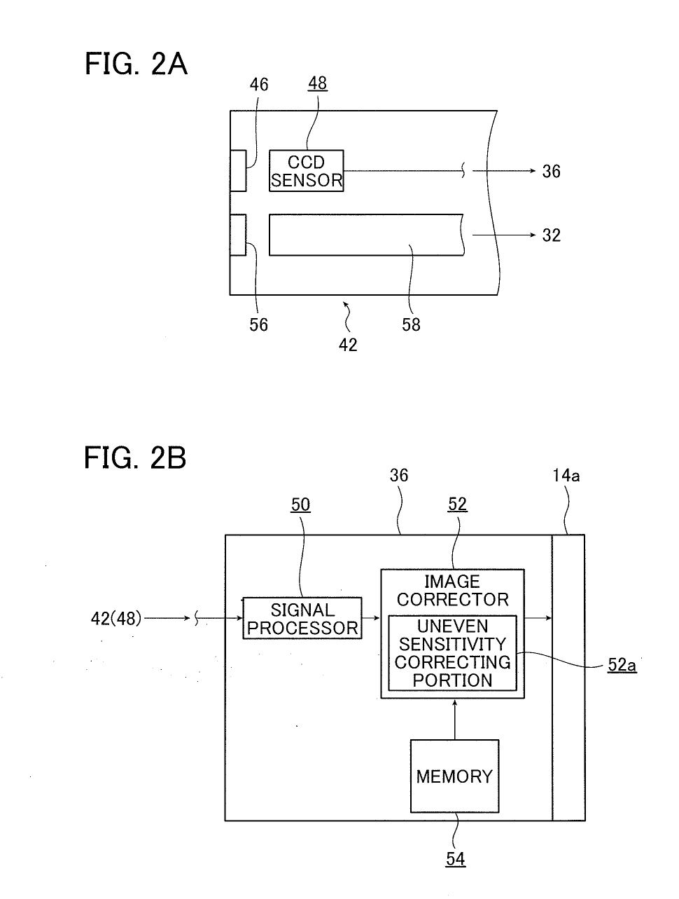

FIG. 2A is a conceptual block diagram showing the configuration of the scope portion 42.

As shown in FIG. 2A, the scope portion 42 is provided with an imaging lens 46, a CCD sensor ((solid-state) image sensor) 48, an illumination lens 56 and a light guide 58.

Although not shown, the scope portion 42 is also provided with a forceps channel and a forceps port for inserting various treatment tools such as a forceps, and air supply/water supply channels and air supply/water supply ports for use in suction, air supply and water supply. The forceps channel extends through the bending portion 40 and the flexible portion 38 to communicate with a forceps insertion port provided in the operating section 28, and the air supply/water supply channels extend through the bending portion 40, the flexible portion 38, the operating section 28 and the universal cord 30 to communicate with connecting portions with a suction means, an air supply means and a water supply means in the connector 32.

The light guide 58 extends through the bending portion 40, the flexible portion 38, the operating section 28 and the universal cord 30 and terminated by the connector 32 which is connected to the light source device 16.

Light emitted from the light source device 16 enters the light guide 58 through the connector 32 and is propagated in the light guide 58. In the scope portion 42, the light enters the illumination lens 56 from the distal end of the light guide 58 and passes through the illumination lens 56 to be irradiated on the observation site.

The observation site having received the illumination light is imaged through the imaging lens 46 on the light receiving surface of the CCD sensor 48.

Output signals from the CCD sensor 48 are sent on signal lines from the scope portion 42 to the video connector 36 (more specifically signal processor 50) through the bending portion 40, the flexible portion 38, the operating section 28, the universal cord 30 and the connector 32.

During the ordinary observation (diagnosis), the endoscope 12 is used with the video connector 36 and the connector 32 connected to a connecting portion 14a of the processor 14 and a connecting portion 16a of the light source device 16, respectively.

As in a typical endoscope, the connector 32 is further connected to the suction means and air supply means for the suction from and the air supply to the observation site, and the water supply means for the water injection on the observation site.

FIG. 2B is a conceptual block diagram showing the configuration of the video connector 36.

In a preferred embodiment of the illustrated endoscope 12, the video connector 36 (the electronic circuit board of the video connector 36) includes the signal processor 50, an image corrector 52 and a memory 54, and performs predetermined processing on the output signals from the CCD sensor 48.

In other words, the output signals from the CCD sensor 48 are first subjected to predetermined processing steps such as amplification and A/D conversion in the signal processor 50.

The image having undergone the processing in the signal processor 50 is then subjected to predetermined image correction in the image corrector 52 before being sent to the processor 14 through the connecting portion 14a with which the video connector 36 is connected. The image corrector 52 uses correction parameters stored in the memory 54 to perform the image correction. The image corrector 52 is provided with an uneven sensitivity correcting portion 52a for correcting uneven sensitivity.

There is no particular limitation on the image correction steps performed in the image corrector 52 of the video connector 36 in the endoscope 12 and various image correction steps (image processing steps) may be performed.

Exemplary image correction steps include the uneven sensitivity correction performed in the uneven sensitivity correcting portion 52a (uneven gain correction or gain variation correction), offset correction (dark current correction), defective pixel correction, white balance adjustment, hue/saturation correction and gamma correction (gradation correction).

In the endoscope 12 making up the endoscope system of the invention, uneven sensitivity is corrected in the uneven sensitivity correcting portion 52a so that dispersion of the low-frequency components on the entire image due to deterioration of marginal luminosity or the like is removed to correct only dispersion of the high-frequency components which may be easily mistaken for a lesion (correction parameters for correcting uneven sensitivity are set so that the dispersion of the high-frequency components may only be corrected). This point will be described in detail later.

The correction steps in the image corrector 52 may be performed by a known method in which correction parameters previously generated and stored in the memory 54 are used to process image data. Uneven sensitivity correction using the uneven sensitivity correction parameters may be basically performed in the same manner as any known uneven sensitivity correction.

In the illustrated case, the correction parameters stored in the memory 54 are updated at predetermined intervals such as at the time of startup, once a day, or once a week (calibration of the endoscope 12 is made). The endoscope 12 may also be calibrated by any known method.

However, the invention is not limited to this. For example, in such a configuration that the endoscope 12 and the processor 14 do not have a means for generating correction parameters but a dedicated device for generating correction parameters in the image corrector 52 is used, the dedicated device may be used to generate correction parameters at the time of factory shipment and be supplied to and stored in the memory 54 of the video connector 36 in the endoscope 12. In this configuration, the correction parameters may not be necessarily updated.

In addition, depending on the type of image correction to be performed, correction parameters corresponding to the observation under special light and the observation under white light, respectively may be optionally stored in the memory 54 so that the image corrector 52 may perform the image correction using the correction parameter suitable to the observation light.

In the preferred embodiment of the illustrated system, the video connector 36 of the endoscope 12 includes the signal processor 50, the image corrector 52 and the memory 54. However, this is not the sole case of the invention.

If possible, the signal processor 50, the image corrector 52 and the memory 54 may be disposed, for example, in the scope portion 42 of the endoscope 12. Alternatively, only the signal processor 50 may be disposed in the scope portion 42.

The configuration in which the signal processor 50, the image corrector 52 and the memory 54 are all disposed in the processor 14 is also possible. Another configuration is also possible in which only the signal processor 50 is disposed in the video connector 36 (endoscope 12), whereas the image corrector 52 and the memory 54 are disposed in the processor 14.

Still another configuration is also possible in which some of the processing functions of the signal processor 50 are provided in the video connector 36, whereas the other processing functions of the signal processor 50 as well as the image corrector 52 and the memory 54 are provided in the processor 14. Yet another configuration is also possible in which the signal processor 50 and some of the correction functions of the image corrector 52 are provided in the video connector 36, whereas the other correction functions of the image corrector 52 are provided in the processor 14. The video connector 36 may be replaced by the connector 32.

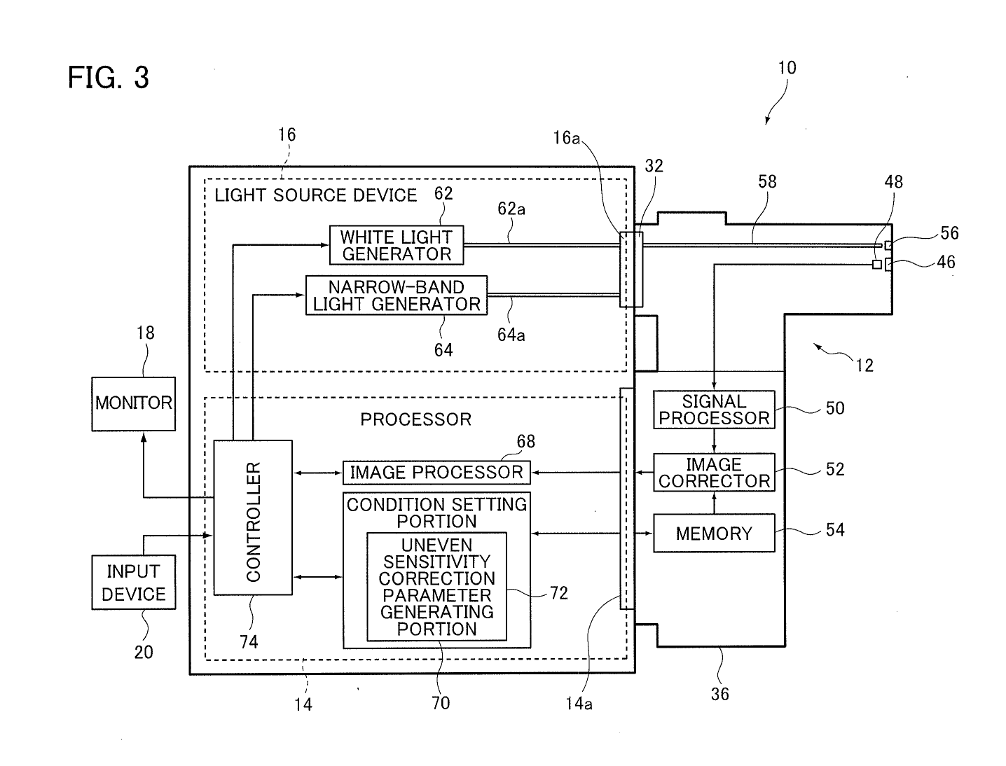

FIG. 3 is a conceptual block diagram showing the configuration of the endoscope system 10.

The light source device 16 is a known illumination device which emits illumination light for the observation using the endoscope 12. As shown in FIG. 3, the illustrated light source device 16 includes a white light generator 62 for the ordinary observation and a narrow-band light generator 64 for the narrow-band light observation. In the invention, the configuration of the light source device is not limited to this but the light source device may include only the white light generator 62. Alternatively, an observation light generator for the observation under special light except the narrow-band light (e.g., infrared light generator for generating infrared light) may be provided instead of or in addition to the narrow-band light generator 64.

White light generated in the white light generator 62 is propagated in a light guide 62a to the connecting portion 16a, whereas narrow-band light generated in the narrow-band light generator 64 is propagated in the light guide 64a to the connecting portion 16a.

Once the connector 32 of the endoscope 12 is connected to the connecting portion 16a, the white light and the narrow-band light used for the observation are both propagated from the connecting portion 16a through the light guide 58 of the endoscope 12 to the scope portion 42, and are irradiated from the illumination lens 56 on the observation site.

The processor 14 performs predetermined processing on the image captured by the endoscope 12 and causes the monitor 18 to display the processed image, and includes an image processor 68, a condition setting portion 70 and a controller 74.

The image captured by the endoscope 12 (image data) is supplied from the video connector 36 to the processor 14. The processor 14 performs various image processing steps in the image processor 68 and causes the monitor 18 to display the processed image.

In addition to the illustrated components, the processor 14 and the light source device 16 may of course include various components of processors and light source devices in known endoscope systems as exemplified by a storage unit and a power supply unit.

The controller 74 is a portion for performing the control of the processor 14 and the whole control of the endoscope system 10.

The image processor 68 subjects the image captured by the endoscope 12 to various image processing steps including processing according to the instruction input from the input device 20, thereby obtaining an image (image data) for displaying on the monitor 18.

There is no particular limitation on the image processing performed in the image processor 68 and various known image processing steps including denoising and edge enhancement (sharpening) may be used. These image processing steps may be performed by a known method implemented in common endoscope systems.

The condition setting portion 70 generates the correction parameters (image correction conditions) for use in the image corrector 52 of the video connector 36, detects defective pixels and sets the image processing conditions in the image processor 68.

In the invention, the operations except the uneven sensitivity correction including the setting of the image processing conditions in the image processor 68, generation of the correction parameters in the image corrector 52 and detection of a defective pixel may be performed by known methods according to the processing to be performed.

In the illustrated case in which the image corrector 52 and the memory 54 are disposed in the video connector 36, the video connector 36 may also be provided with a means for generating correction parameters for use in the image corrector 52 (e.g., uneven sensitivity correction parameters). Alternatively, a dedicated device such as a personal computer for generating correction parameters in the image corrector 52 may be used to generate correction parameters and supply them to the memory 54 of the video connector 36 or a memory provided in the endoscope 12 or the processor 14.

As described above, the condition setting portion 70 includes an uneven sensitivity correction parameter generating portion 72.

The uneven sensitivity correction parameter generating portion 72 generates correction parameters for use in correcting uneven sensitivity in the uneven sensitivity correcting portion 52a in the image corrector 52 of the video connector 36. In the endoscope system 10 of the invention, uneven sensitivity is not corrected so as to make the whole screen uniform as in the uneven sensitivity correction performed in a common endoscope system but is corrected only for the dispersion of the high-frequency components. More specifically, the uneven sensitivity correction parameter generating portion 72 sets correction parameters for correcting the uneven sensitivity so that the dispersion of the high-frequency components of the image may only be corrected.

The endoscope system 10 of the invention is described below in further detail by explaining the operations of the condition setting portion 70 and the uneven sensitivity correction parameter generating portion 72.

In the practice of the invention, a parameter for correcting uneven sensitivity may optionally be generated by the method described below for both sides observation under white light and observation under special light. Alternatively, a parameter for correcting uneven sensitivity may be generated by the method described below for each observation light.

In order to generate a correction parameter for correcting uneven sensitivity (to calibrate the endoscope), a correction image for generating a correction parameter for correcting uneven sensitivity and optionally correction parameters for use in other correction steps is created.

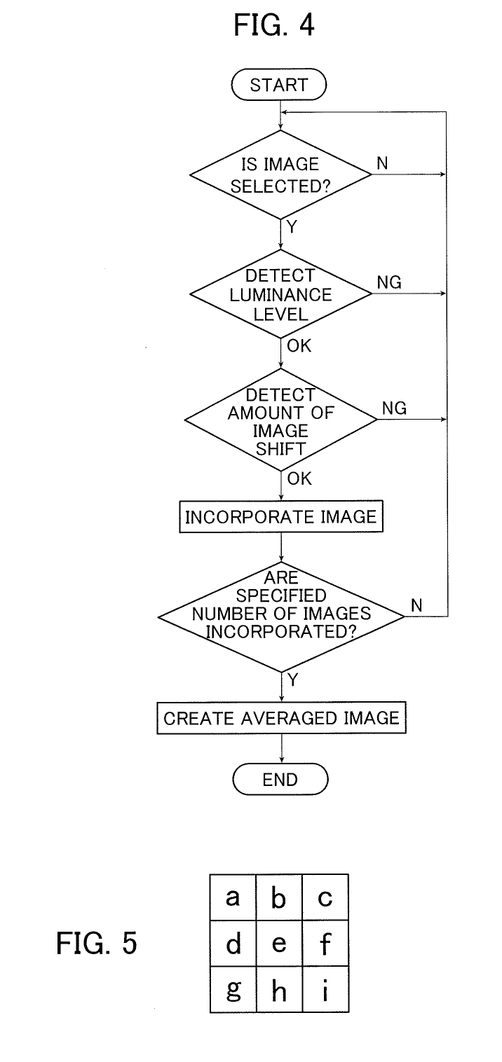

FIG. 4 is a flow chart illustrating an example of the method of creating a correction image.

Upon issuance of an instruction for generating a correction parameter for correcting uneven sensitivity (an instruction for starting the calibration of the endoscope 12), the controller 74 causes the monitor 18 to display an instruction for starting shooting to create a correction image.

The correction image creating method is not particularly limited and various known methods which are implemented to correct uneven sensitivity may be used. For example, the correction image is created by shooting an object with a uniform concentration such as a white object using the endoscope 12. Alternatively, the correction image may be created using not an object with a uniform concentration but an image captured during the observation using the endoscope 12 (ordinary image).

The method illustrated in the flow chart of FIG. 4 is a particularly preferred method when creating a correction image using an ordinary image. Therefore, in cases where an object with a uniform concentration is shot to create a correction image, another method may also be preferably used in which a correction image is created from one image or an average image of a plurality of captured images.

The image captured to create the correction image is supplied to the condition setting portion 70, where it is subjected to processing steps to be described later. In this process, the image (image data) processed in the signal processor 50 of the video connector 36 is not processed in the image corrector 52 but is output from the video connector 36 to be supplied to the condition setting portion 70 of the processor 14.

Prior to shooting for generating a correction parameter for use in correcting uneven sensitivity or in order to generate a correction parameter for offset correction (dark current correction), an image is captured with the scope portion 42 completely shielded from light and is supplied to the condition setting portion 70 to generate an offset correction parameter. As described above, the offset correction parameter may be generated by any known method.

The thus generated offset correction parameter is supplied to and stored in the memory 54 of the video connector 36.

The correction image may be created from one image (one frame) but is preferably an averaged image which is created from an appropriately set number (frame number) of images.

In order to prevent the structure of an object from being incorporated in the correction image to obtain an image on which unevenness in the sensitivity of the endoscope 12 is property reflected, it is preferred to create the correction image from a predetermined number of images which were selected from continuous images by thinning out. The monitor 18 is caused to display an instruction for shooting an object at a different site (position) in order to more advantageously eliminate influences of the structure of the object.

Taking a case in which the images are thinned out to one-third, the first and second images are removed and the third image is selected; then the fourth and fifth images are removed and the sixth image is selected; and the same procedure is repeated and the ninth image, the twelfth image, the fifteenth image and the like are selected after thinning out to one-third. The thinning out is not limited to the case where the images are thinned out to one-third and the ratio of thinning out may be appropriately set. The case in which the images are not thinned out (all the images are selected) is also possible but the images are preferably thinned out to half or more.

Then, the condition setting portion 70 detects the luminance level of the selected image to check whether or not the image is captured at a predetermined luminance (NG/OK).

The luminance level is determined by, for example, dividing an image into 9 (3×3) segments and calculating the average luminance of the central region (average signal intensity/average pixel value). The image is regarded as OK when the average luminance falls within a predetermined range and NG when it is outside the predetermined range. In the case of NG, the image is not used to create the correction image.

When the selected image was regarded as NG, the subsequent image may be selected or thinning out and selection may be repeated without any changes.

For example, when the sixth image selected in the foregoing example of thinning out to one-third is regarded as NG, a process may be selected in which the seventh image is selected and the thinning out is repeated in the same way to select the tenth image, thirteenth image and the like. Alternatively, another process may be selected in which the ninth image, the twelfth image and the like are selected in the same way without changing the images to be selected.

In this regard, the same holds true for the detection of the amount of image shift to be described below.

When the luminance level of the selected image is proper, the amount of image shift is then detected.

The amount of image shift refers to an amount of image change. In the illustrated case, images which are different to some extent or have certain changes are selected to create a correction image, whereby the structure of the object is prevented from being incorporated in the correction image to obtain the correction image on which the sensitivity unevenness and the like are properly reflected, as in the foregoing thinning out.

The absolute value of the difference between the selected image and the image for judgment is taken as the amount of image shift. The selected image is regarded OK when the amount of image shift exceeds a predetermined threshold T and NG when it is up to the threshold T. That is,

when |(selected image)−(image for judgment)|>T, the selected image is OK, and

when |(selected image)−(image for judgment)|<T, the selected image is NG and is not used to create a correction image.

An example of the image for judgment is an image just before the selected image (image in the previous frame). For example, the images are compared based on the average luminance and/or the average of all the pixel values.

When an image has a proper amount of image shift, this image is incorporated as an image for creating a correction image and this operation is repeated until the number of incorporated images reaches a predetermined number.

Once the predetermined number of images are incorporated, the condition setting portion 70 creates an averaged image from the incorporated images. The averaged image is called the correction image. The number of incorporated images to create a correction image is not particularly limited and is preferably from about 100 to about 10,000.

In this embodiment, both of the luminance level and the amount of image shift are detected and used for judgment. However, this is not the sole case of the invention and one of both may only be performed.

Once a correction image is created, a defective pixel may be detected prior to generating a parameter for correcting uneven sensitivity in the uneven sensitivity correction parameter generating portion 72.

Various known methods may be used to detect a defective pixel. For example, pixels are determined as follows: the average value in all the pixels is calculated; the pixel value in the pixel of interest (the pixel to be determined for the possibility of a defective pixel) is divided by the calculated average value; and the pixel is regarded as proper when the resulting value falls within a predetermined range and is detected as a defective pixel when it is outside the predetermined range.

Upon detection of a defective pixel in this way, its information (positional information) is supplied to the memory 54 of the video connector 36 and stored therein. The image corrector 52 uses the information on the defective pixel as the correction parameter to correct the defective pixel.

As described above, the defective pixel may be corrected by any known method such as interpolation using peripheral pixels to be described later.

Upon creation of a correction image in the condition setting portion 70, the correction image is supplied to the uneven sensitivity correction parameter generating portion 72.

As described above, the uneven sensitivity correction parameter generating portion 72 is a portion where an uneven sensitivity correction parameter for correcting uneven sensitivity of the endoscope 12 is generated. In the endoscope system 10 of the invention, a correction parameter for correcting uneven sensitivity is set so that dispersion of the low-frequency components on the entire image due to deterioration of marginal luminosity is removed to correct only dispersion of the high-frequency components which may be easily mistaken for a lesion.

As described above, the characteristic variations of the pixels of the CCD sensor 48 in the endoscope 12 are affected by the characteristics of the pixels of the CCD sensor 48 but also the state of the imaging lens 46 and that of the light receiving surface of the CCD sensor 48. Therefore, uneven sensitivity is to be corrected (a parameter for correcting uneven sensitivity is to be generated) with the imaging lens 46 mounted on the endoscope 12.

However, as is well known, the imaging lens 46 of the endoscope 12 is a very compact and wide-angle lens. Therefore, the imaging lens 46 has large distortion and in a common endoscope, the quantity of light in the peripheral portion (quantity of light incident on the peripheral portion of the CCD sensor 48) is about one-third that of the central portion.

Uneven sensitivity correction performed with uneven quantity of light so as to make the image uniform on the whole surface may increase the amount of correction (amount of amplification) in the peripheral portion compared to the central portion. As a result, as described above, the peripheral portion of the image has an increased noise level and on the other hand the image quality may deteriorate on the entire image.

In the case of observation under special light such as observation under infrared light or observation under narrow-band light, output signals from the CCD sensor 48 are to be considerably amplified. Therefore, uneven sensitivity correction to make the entire image uniform may considerably increase the noise in the peripheral portion, thus further deteriorating the image quality due to the noise in the peripheral portion.

In order to solve this problem, in the endoscope system 10 of the invention, uneven sensitivity is corrected so that dispersion of the low-frequency components on the entire image due to deterioration of marginal luminosity or the like is removed to correct only dispersion of the high-frequency components which may be mistaken for a lesion. In other words, the dispersion is corrected not for the low-frequency components which has a quite different image structure from that of a lesion and which is very unlikely to be mistaken for the lesion but only for the high-frequency components which is easily mistaken for the lesion.

Therefore, according to the invention, noise in the peripheral portion can be prevented from being enhanced by deterioration of marginal luminosity or the like to output an image which is properly corrected for unevenness as a whole and is capable of a correct diagnosis.

More specifically, four methods are advantageously used to generate a parameter for correcting uneven sensitivity only for the high-frequency components.

An exemplary method involves generating a parameter for correcting uneven sensitivity so that the uneven sensitivity is corrected not in the peripheral portion with a large decrease in the quantity of light but in the central portion of the image.

For example, a region whose quantity of light is at least two-thirds that of the center is detected in the correction image (CCD sensor 48) and an average of pixel values in the detected region is calculated. Then, the uneven sensitivity correction parameter is calculated for all the pixels of the detected region so that the pixel values of the correction image multiplied by the correction parameter may have the foregoing average value. In the other peripheral region whose quantity of light is less than one-third that in the central portion, the uneven sensitivity correction parameter is set to “1” and uneven sensitivity correction is not performed.

Alternatively, instead of dividing the correction image into the central and peripheral portions by quantity of light, the correction image may be divided, for example, nine segments so that the uneven sensitivity correction parameter is calculated in the same manner as above for the central portion and the peripheral region is not corrected for uneven sensitivity based on the uneven sensitivity correction parameter set to “1”.

In cases where a pixel of interest for which the parameter for correcting uneven sensitivity is to be calculated is a defective pixel, this pixel is deemed to have an uneven sensitivity correction parameter of “1”. In cases where a defective pixel is present in the region for which the average value is to be calculated, the defective pixel is removed and the average value in the pixels remaining after removal of the defective pixel is calculated.

Alternatively, the uneven sensitivity correction parameter may be calculated after the defective pixel correction which involves averaging four pixels on the upper, lower, left and right sides of a defective pixel or eight pixels surrounding the defective pixel and using the resulting average value as the pixel value of the defective pixel.

In this regard, the average value and the parameter for correcting uneven sensitivity are calculated in the same manner also in the method of generating the uneven sensitivity correction parameter to be described later.

Another method that may be advantageously used to generate a parameter for correcting uneven sensitivity so as to enable uneven sensitivity of the high-frequency components to be only corrected include dividing a plurality of correction images into, for example, 9 to 100 segments and generating an uneven sensitivity correction parameter in each pixel so as to correct uneven sensitivity for each of the segments.

For example, a correction image is divided into 9 segments a to i as conceptually shown in FIG. 5. First, the average pixel value is calculated in the region a and the uneven sensitivity correction parameter is calculated for all the pixels in the region a so that the pixel values of the correction image multiplied by the correction parameter may have the foregoing average value in the region a. Then, the average pixel value is calculated in the region b and the uneven sensitivity correction parameter is calculated for all the pixels in the region b so that the pixel values of the correction image multiplied by the correction parameter may have the foregoing average value in the region b. The uneven sensitivity correction parameters are sequentially calculated for the regions including region c, region d . . . and region i to thereby generate the uneven sensitivity correction parameter for the entire image.

Yet another method that may be advantageously used to generate a parameter for correcting uneven sensitivity so as to enable uneven sensitivity of high-frequency components to be only corrected include processing a correction image with a high-pass filter to extract high-frequency components and generating the parameter for correcting uneven sensitivity only for the high-frequency components.

More specifically, the average value in all the pixels of the corrected image is calculated. The corrected image is processed with a high-pass filter to extract the high-frequency components. Then, the uneven sensitivity correction parameter is calculated for the pixels of the extracted high-frequency components of the correction image so that the pixel values of the correction image multiplied by the correction parameter may have the foregoing average value. The uneven sensitivity parameter is set to “1” in the other pixels or pixels which did not pass through the high-pass filter and uneven sensitivity correction is not performed.

The uneven sensitivity correction parameter may be calculated in the same manner using the average value in pixels surrounding a pixel in the extracted high-frequency components (e.g., peripheral 8 pixels or peripheral 24 pixels) instead of the average value in all the pixels of the correction image.

The high-frequency components may also be extracted by a method which involves processing the correction image with a low-pass filter to extract low-frequency components (low-frequency components and medium-frequency components) and subtracting the image in the low-frequency components from the correction image.

Still another method that may be advantageously used to generate a parameter for correcting uneven sensitivity so as to enable uneven sensitivity of high-frequency components to be only corrected include calculating an uneven sensitivity correction parameter as usual, regarding it as a temporary correction parameter and correcting the temporary correction parameter using information on the deterioration of marginal luminosity (shading information).

More specifically, the correction image is analyzed to detect the state of deterioration of peripheral luminosity. The average value in the correction image is calculated. Once the average value in the correction image is calculated, the temporary uneven sensitivity correction parameter is calculated for all the pixels in the correction image so that the pixel values of the correction image multiplied by the correction parameter may have the foregoing average value.

The temporary uneven sensitivity correction parameter is corrected so that variations in the pixel value due to the deterioration of marginal luminosity may remain depending on the state of the detected deterioration of marginal luminosity (so that the peripheral pixels may have a reduced luminance) thereby calculating the uneven sensitivity correction parameter.

The temporary uneven sensitivity correction parameter may be corrected by multiplying the luminance ratio between the average luminance in the vicinity of the pixel of interest and the average luminance of all the pixels by the temporary uneven sensitivity correction parameter. Five pixels including upper-, lower-, left- and right-side four pixels or nine pixels including peripheral eight pixels may be used to determine the average luminance in the vicinity of the pixel of interest. The average luminance may be replaced by the average pixel value.

Upon generation of the uneven sensitivity correction parameter in the uneven sensitivity correction parameter generating portion 72, the thus generated uneven sensitivity correction parameter is supplied through the connecting portion 14a to the video connector 36. The uneven sensitivity correction parameter supplied to the video connector 36 is stored in the memory 54.

When shooting (observation) is made with the endoscope 12, the uneven sensitivity correcting portion 52a of the image corrector 52 reads out parameters for correcting uneven sensitivity from the memory 54 and multiplying the image (image data) of each pixel by its corresponding uneven sensitivity correction parameter to correct uneven sensitivity. In consideration of the offset of the CCD sensor 48, the image corrector 52 preferably corrects uneven sensitivity according to the following formula using a correction parameter for offset correction:

G′=(G−offset)H+offset

wherein G is image data to be corrected for uneven sensitivity; H is an uneven sensitivity correction parameter; and G′ is image data corrected for uneven sensitivity.

In this process, the correction parameter for offset correction may be a correction parameter generated for each pixel (offset for each pixel). Alternatively, a single correction parameter which is shared by all the pixels may be used. The correction parameter for offset correction which is shared by all the pixels may be an average offset in all pixels.

As described above, the uneven sensitivity correction parameter is set to remove dispersion of the low-frequency components to correct only dispersion of the high-frequency components.

Therefore, the image which was corrected for uneven sensitivity in the image corrector 52 can prevent noise in the peripheral portion of the image from being enhanced, is properly corrected for unevenness as a whole and is capable of a correct diagnosis.

While the endoscope system of the invention has been described above in detail, the invention is by no means limited to the above embodiments, and various improvements and modifications may of course be made without departing from the spirit of the present invention.

The endoscope system of the invention may be advantageously utilized in medical settings making use of endoscopes.

What is claimed is:

1. An endoscope system comprising:
an endoscope for capturing an image with an image sensor;
storage means for storing an uneven sensitivity correction parameter;
uneven sensitivity correction means for correcting uneven sensitivity of said image sensor using said uneven sensitivity correction parameter stored in said storage means; and
parameter generating means for generating said uneven sensitivity correction parameter,
wherein said parameter generating means creates a correction image from the image captured by said image sensor and generates said uneven sensitivity correction parameter so as to correct only high-frequency components of the correction image.

2. The endoscope system according to claim 1, wherein said parameter generating means extracts the high-frequency components from said correction image and generates said uneven sensitivity correction parameter so that the extracted high-frequency components are only corrected for the uneven sensitivity.

3. The endoscope system according to claim 1, wherein said parameter generating means generates a temporary uneven sensitivity correction parameter for entirely correcting the uneven sensitivity of said correction image and corrects the temporary uneven sensitivity correction parameter with information previously acquired on shading of said endoscope to generate said uneven sensitivity correction parameter.

4. The endoscope system according to claim 1, wherein said parameter generating means generates said uneven sensitivity correction parameter so that a central portion of said correction image is only corrected for the uneven sensitivity.

5. The endoscope system according to claim 4, wherein said central portion of said correction image is a region of image data whose quantity of light is at least two-thirds that of a center.

6. The endoscope system according to claim 1, wherein said parameter generating means divides said correction image into segments and generates said uneven sensitivity correction parameter so that said uneven sensitivity is corrected for each of said segments.

7. The endoscope system according to claim 1, which has a function of observation under special light.

8. The endoscope system according to claim 1, wherein said parameter generating means selects a predetermined number of images by thinning out images captured by the image sensor for creating said correction image and uses the predetermined number of selected images to create said correction image.

9. The endoscope system according to claim 8, wherein when average image data of a specified region in an image of said predetermined number of selected images is outside a prescribed range, said parameter generating means does not use said image to create said correction image.

10. The endoscope system according to claim 8, wherein when an image of said predetermined number of selected images does not have variations exceeding a specified threshold with respect to a specified image for judgment, said parameter generating means does not use said image to create said correction image.

11. The endoscope system according to claim 1, wherein said storage means and said uneven sensitivity correction means are disposed in said endoscope.

12. The endoscope system according to claim 1, wherein said parameter generating means is disposed in said endoscope.

13. The endoscope system according to claim 1, wherein said parameter generating means is disposed in a portion other than said endoscope.
